(19) United States
(12) Patent Application Publication
(10) Pub. No.: US 2005/0213647 A1
(43) Pub. Date: Sep. 29, 2005

(54) Flexible power line modem

(75) Inventor: Liyang Zhang, Singapore (SG)

Correspondence Address: CONLEY ROSE, P.C., P. O. BOX 3267, HOUSTON, TX, 77253-3267, US

(73) Assignee: Agency for Science, Technology and Research, Singapore (SG)

(21) Appl. No.: 10/514,747

(22) PCT Filed: May 17, 2002
(86) PCT No.: PCT/SG02/00100

§ 371 Date: May 19, 2005

(51) Int. Cl. H04B 1/38

(52) U.S. Cl. 375/222

(57) ABSTRACT

The present invention is a universal power line modem for any type of power line communication network. The main idea of the invention is that the functions of different kinds of power line networks (different protocols and modulation/demodulation methods) will be realized by software based on one general, standard and modularized hardware platform which is based on DSP chip or FPGA.

### FIELD OF THE INVENTION

The present invention is related generally to the utilisation of electrical utility power lines. More particularly, this invention is related to a technique for transmitting and receiving digital information within an electric utility power line network.

### BACKGROUND OF THE INVENTION

Power line networks interconnect almost every home and business in the world.

It would be highly desirable to utilise this established infrastructure to deliver digital information. A system of passing digital information over power lines could be exploited in a large number of ways, including LAN, remote meter reading, load control, status checks on switches and related electrical equipment, telemetry, and so on.

There are a number of power-line network products currently available, for example Lonwork's 2-carrier product, Inari's 4-carrier product and Intellon's ODFM product. One of the major problems with existing products is that they use different protocols and modulation standards that are incompatible. Therefore, these products are incompatible. That is for example an Intellon modem will not provide access to an Inari power line network.

In view of the foregoing, it would be highly desirable to provide a system for implementing digital communication in a power line network.

### OBJECT OF INVENTION

It is therefore an object of the present invention to provide a power-line modem that has compatibility with a majority of power line based products which are based on DSP and FPGA technology.

### SUMMARY OF THE INVENTION

With the above object in mind the present invention provides a flexible modem for transmitting and receiving signals via power-lines, including:
a programmable transmitter using digital signal processing including a digital signal processor and a controller for the modem functional control, which includes wave shaping, coupling units needed to transmission process and computer bus interfaces;
a programmable receiver using digital signal processing including a digital signal processor and a controller for the modem functional control, which includes wave shaping, and coupling units needed in receiver process and computer bus interfaces;
at least one random access memory for storage of data; and
a clock generator coupled to the transmitter and receiver.

The wave shaping is used to transform the input signal to a required wave form. This may be acheieved by a digital modulator, digital mixer, digital filter, or other such devices. The computer bus interface can be used to connect the major components of the system to thereby allow the transfer of electric impulses from one connected component to any other. Ideally this will be connected as a parallell circuit. A digital frequency synthesiser may be used to generate different frequency signals which may be required by different parts of the system which may be determined based on the clock from the clock generator.

In an alternative embodiment the present invention provides a modem for transmitting and/or receiving a signal via a power line, said modem including: a local interface for providing a link between a device and said modem;
a controller;
a modulation means;
a data conversion means;
a coupling means for providing a link between said modem and said power line; and
a memory means, said memory means storing a plurality of algorithms, each said algorithm being selectable by said controller, said controller selecting said algorithm and using said selected algorithm to convert said signal;
wherein to transmit said signal, said controller receives said signal from said local interface and converts said signal using said selected algorithm into a format acceptable by said power line, said converted signal is modulated by said modulation means and passed to said data conversion means to convert said signal into an analog signal, said coupling means then transfers said analog signal into said power line; and
wherein to receive said signal, said data conversion means receives said signal from said coupling means and converts said signal using said selected algorithm into a digital signal, said digital signal is demodulated in said modulation means and forwarded to said controller, said controller converts said signal into a format acceptable by said device, and said local interface outputs said data to said device.

In a further aspect the present invention provides a transmitter for transmitting data across a power line, said transmitter including:
a local interface for receiving data from a device, said data to be transmitted across said power line;
a controller for receiving said data from said local interface and converting said data into a power line network data format;
a modulator for modulating said data in said power line network data format to create a digital power line signal;
a digital to analog converter for converting said digital power line signal into an analog power line signal; and
a coupling means to enable said analog power line signal to be transferred into said power line.

In yet a further aspect the present invention provides a receiver for receiving an analog power line signal from a power line, said receiver including:
a coupling means to enable said analog power line signal to be received;
an analog to digital converter for converting said analog power line signal into a digital power line signal;
a demodulator for demodulating said digital power line signal into data;
a controller for converting said data into a required interface protocol format; and
a local interface for outputting said data in said interface protocol format to a device.

In a further aspect the present invention provides a method for transmitting data across a power line, including the steps of:
converting said data into a power line network data format;
modulating said data in said power line network data format to create a digital power line signal;
converting said digital power line signal into an analog power line signal; and
transferring said analog power line signal into said power line.

In still a further aspect the present invention provides a method of processing analog power line signals from a power line, including the steps of:
receiving said analog power line signal;
converting said analog power line signal into a digital power line signal;
demodulating said digital power line signal into data;
converting said data into a required interface protocol format; and
outputting said data in said interface protocol format to a device.

### BRIEF DESCRIPTION OF THE DRAWINGS

FIG. 1 shows a block diagram of the preferred embodiment of the present invention.

FIG. 2 exemplifies the data flow when the present invention is in transmit mode.

FIG. 3 exemplifies the functional operation of the DSP module of the present invention.

FIG. 4 shows a FSK modulator.

FIG. 5 shows a PSK modulator.

FIG. 6 shows an OFDM-FM modulator.

FIG. 7 shows the coupling used in the preferred embodiment of the present invention.

FIG. 8 shows a block diagram for an ADC and DSP module.

FIG. 9 shows a functional diagram of the DSP module.

FIG. 10 shows a FSK demodulator.

FIG. 11 shows a PSK demodulator.

FIG. 12 shows an OFDM-FM demodulator.

### DETAILED DESCRIPTION OF THE INVENTION

The present invention provides a universal power-line modem for power line communication networks. The main idea of the invention is that the functions of different kinds of power line networks (different protocols and modulation/demodulation methods) will be realised by software based on one general, standard and modularised hardware platform.

The device ideally includes both a transmitting mode and a receiving mode. In the transmit mode, the data from a local interface can be transmitted into the power line after forming protocol, modulation, and filtering, etc. In the receive mode, data can be retrieved after the signal from a power line is filtered, demodulated, and protocol transferred, etc.

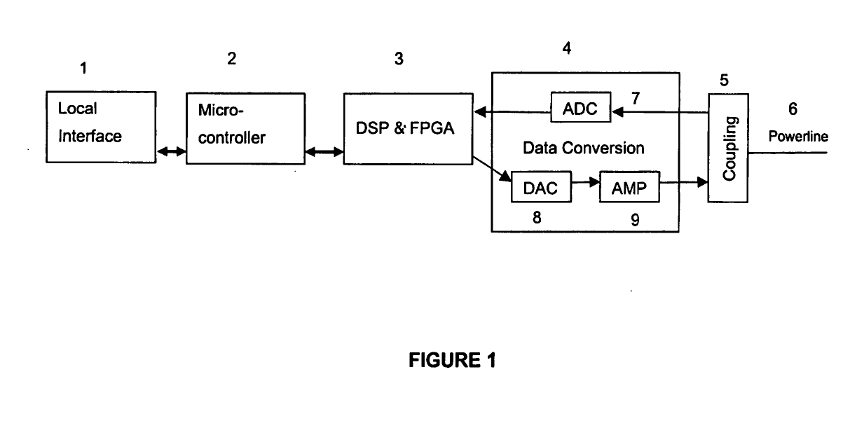

Reverting now to the figures for a better understanding of the invention. The overall system of the preferred embodiment is shown in FIG. 1. Conveniently some units in the modem may be used in both transmit mode and receive mode, e.g. Coupling.

For convenience the modem will be considered as both a transmitter and a receiver and explained separately as follows:

The transmitter may include 6 modules, namely, a Local Interface (1), Micro-controller (2), Digital to Analog Converter (DAC) (8), Digital Signal Processor (DSP) or Field Programmable Gate Array (FPGA) (3), Amplifier (9), and Coupling (5).

In this arrangement the transmitted signal stream may be as follows:
a) The Local Interface module 1 feeds the input data from other devices, for example a personal computer, into the Micro-controller module 2.
b) In the Micro-controller module 2, the data from the Local Interface 1 will be converted into an acceptable power-line network data format. For example the module could convert data from USB format to Inari PLX format. The converted data is then passed to the DSP/FPGA module 3, and the signal transformed to the required power-line signal, e.g. meeting the required frequency, modulation, etc.
c) The power-line format data from the Micro-controller 2 will be modulated and digitally filtered to generate the digital power line signal in the DSP/FPGA module 3.
d) The digital power line signal will be converted into an analog power line signal in the DAC module 8.
e) The analog power line signal will be transferred into the power line through the Coupling module 5 after power amplification in the Amplifier(s) module 9.

The receiver in this arrangement may include 5 modules, namely a Coupling (5), Analog to Digital Converter (ADC) (7), DSP/FPGA (3), Micro controller (2) and Local Interface (1). The received signal stream can be as follows:
a) The original signal from a power line 6 (analog signal and noise) will be coupled to the ADC module 7 by a transformer and capacitors in the Coupling module 5.
b) The coupled signal will be sampled and digitised in the ADC module 7.
c) The data will be retrieved through the digital filters, and demodulation and equalization (if necessary) carried out in the DSP/FPGA module 3.
d) In the Micro-controller module 2, the retrieved data will be converted to a certain interface protocol format, e.g., RS-232, USB.
e) The data will be output to other devices through the Local Interface module 1.

In the preferred system analog amplifiers will not be necessary in the receiver because the received signals in power-line communication networks are large enough for the ADC. Therefore the receiver of the power-line module can almost be a pure digital device, which is more flexible.

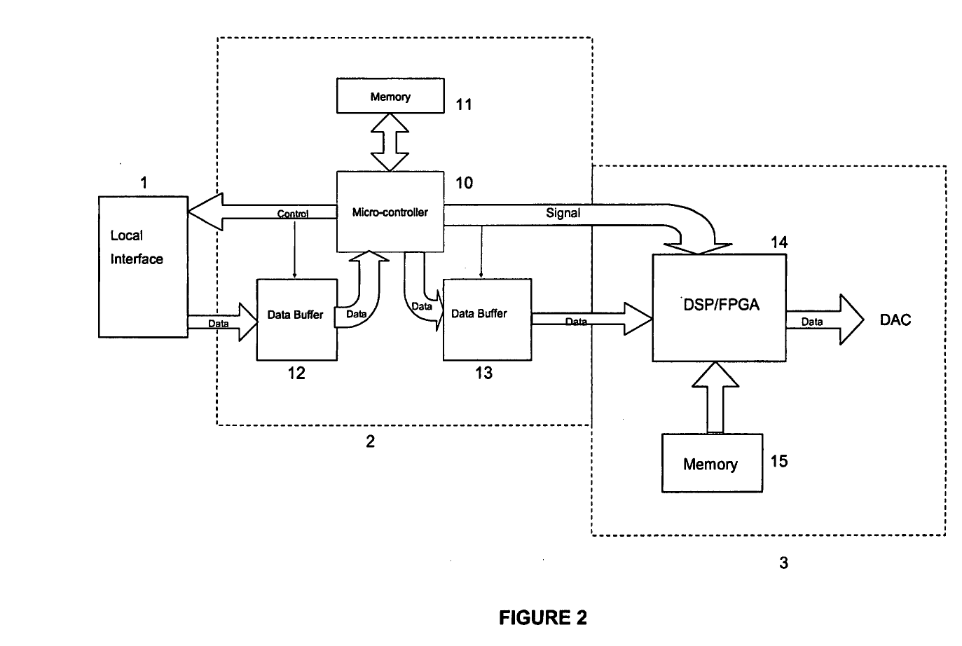

Turning now to the transmitter and referring to FIGS. 2 to 7 the function of the transmitter can be more clearly described. The transmitter includes a Local Interface Module 1, which can provide an interface between the Micro-controller module 2 and the other devices, e.g., connecting a PC with the Power-line Modem, using a USB port.

The Micro-controller module 2 can ideally provide 3 functions. The first is system control. The micro-controller 10, controls the whole system, such as switching on/off the Amplifier module 9, initiating the Local Interface module 1, and selecting the algorithm stored in the memory (15) for the DSP/FPGA module 3. The second function of the Micro-controller module 2 is bit-stream processing, e.g., converting the data from USB data link format to Power-line data link format and channel encoding as shown in FIG. 2.

The Micro-Controller 10 is able to control the Local Interface module 1 through use of control signals. When initiated the Local Interface 1 may transmit data into the Data Buffer 12 of the Micro-Controller 10. The Micro-Controller 10 selects the algorithm from Memory 11 to enable the data to be converted into one of the acceptable power-line network data formats. The algorithm can be selected manually by setting an appropriate switch on the modem, thereby causing the micro controller to select the desired algorithm. This formatted data is then outputted to the Data Buffer 13 for the DSP module 14. Control signals can also be sent from the Micro-Controller 10 to the DSP module. These control signals could for example include the modulation method and transmitted frequency.

A DSP may be considered as a special purpose micro-processor with an architecture suitable for fast execution of signal processing algorithms. An FPGA is an assembled chip containing an array of logic elements which can be interconnected by the user by means of hardware or software.

The DSP module 3 is a key module in the transmitter of the modem. As can be seen in FIG. 2, data from the Micro-Controller module 2 is inputted into the DSP/FPGA 14. The processed data is then output to the DAC module 8. The DSP/FPGA chip may be controlled by the Micro-Controller module 11 and its program can also be stored in the Memory Unit 15.

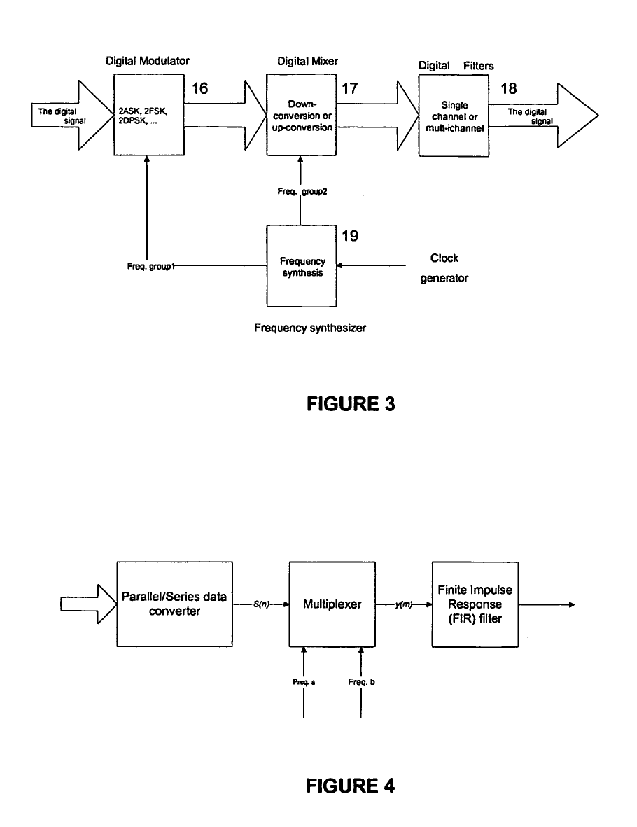

The function of the DSP/FPGA module 14 is exemplified in FIG. 3. It can be seen that the data will initially be modulated in the modulator 16. The algorithm in the modulator 16 is one of the modulation algorithms. It may be single carrier modulation or multi-carrier modulation, including 2ASK, 2FSK, 2DPSK, MASK, QPSK, QAN, MSK, GMSK, or OFDM, etc. It will be controlled by the Micro-controller 10 for the DSP/FPGA module 3 to call one or more of the different algorithms stored in the memory. These algorithms may be stored in different addresses in the memory allowing the DSP to access the corresponding addresses for the algorithms, in accordance to a command from the Micro-Controller unit. The modulated data will be output to DAC module through the transmitting filter, which is a digital band pass filter (BPF).

The function of the digital modulator is to modulate the baseband signal to a transmitter signal. There are a number of algorithms that may be used for modulation.

For example, if the modulation algorithm is a single carry Frequency Shift Key (FSK), the block diagram of the modulator is shown as in FIG. 4. Where:

$$y ( m ) = \{ \begin{matrix}cos ( m \cdot Freq . a + φ ) & If s ( n ) = 1 \\ cos ( m \cdot Freq . b + φ ) & If s ( n ) = 0\end{matrix}$$

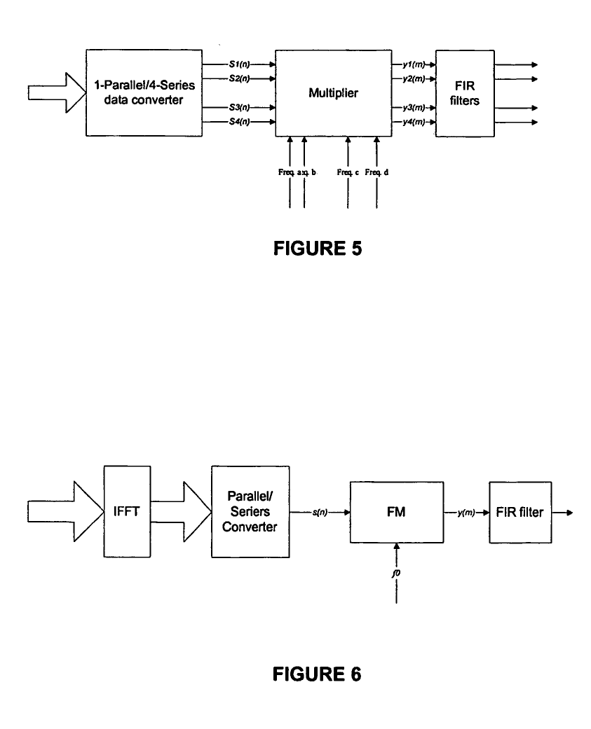

If the modulation algorithm is a four-carry Phase Shift Key (PSK), the block diagram of the modulator is shown in FIG. 5. Where:

$$y 1 ( m ) = \{ \begin{matrix}cos ( m \cdot Freq . a + {φ}_{1} ) & if s 1 ( n ) = 0 \\ - cos ( m \cdot Freq . a + {φ}_{2} ) & if s 1 ( n ) = 1\end{matrix} \\ y 2 ( m ) = \{ \begin{matrix}cos ( m \cdot Freq . b + {φ}_{3} ) & if s 2 ( n ) = 0 \\ - cos ( m \cdot Freq . b + {φ}_{4} ) & if s 2 ( n ) = 1\end{matrix} \\ y 3 ( m ) = \{ \begin{matrix}cos ( m \cdot Freq . c + {φ}_{5} ) & if s 3 ( n ) = 0 \\ - cos ( m \cdot Freq . c + {φ}_{6} ) & if s 3 ( n ) = 1\end{matrix} \\ y 4 ( m ) = \{ \begin{matrix}cos ( m \cdot Freq . d + {φ}_{7} ) & if s 4 ( n ) = 0 \\ - cos ( m \cdot Freq . d + {φ}_{8} ) & if s 4 ( n ) = 1\end{matrix}$$

If the modulation algorithm is an Orthogonal Frequency Division Multiplex outside the FM band (OFDM-FM), the block diagram of the modulator is shown in FIG. 6. Where:
y(m)=cos{m·[2πf₀+s(n)]+φ}

The function of the digital mixer 17 is to move the central frequency of the signal to a proper frequency for transmitting. This may take the form:
z(m)=x(m)+e^{±/worn}.

The function of the Finite Impulse Response (FIR) filter is to reduce any unnecessary frequency components.

The DAC module is the module that converts the digital signal to the analog signal.

The function of the AMP module 9 is to power amplify the analog signal from the DAC module 8 and then transmit it into the power-line 6 channel. And it also ideally includes an Electro-adjustment analog low pass filter (LPF) to filter the noise from the DAC.

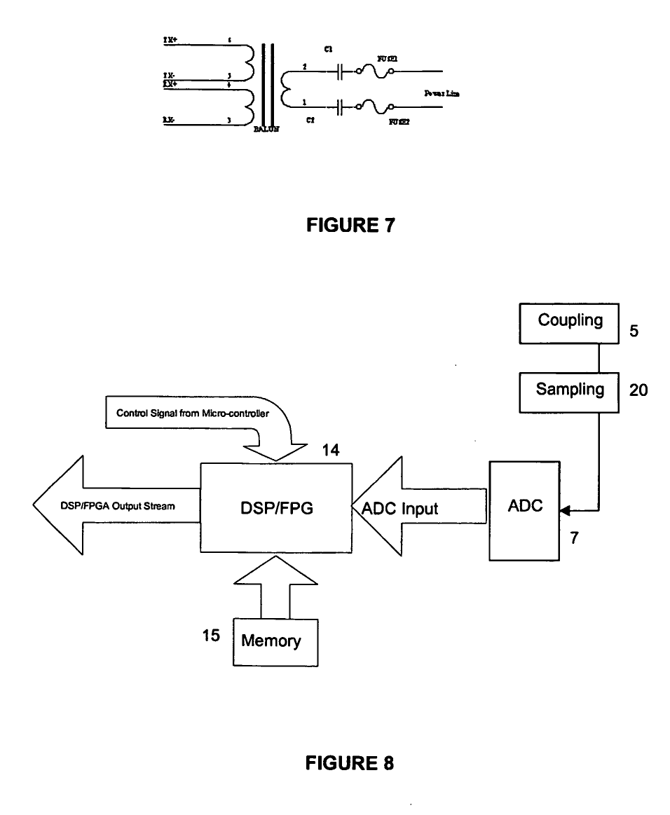

The function of the coupling module 5 is to insulate the electric supply and couple communication signal from or into power lines. It may include a balun and two capacitors as shown in FIG. 7.

Considering the modem in receive mode the coupling module in the receiver can be the same one as used in the transmitter. Both transmitter and receiver should ideally use an identical Coupling module.

There are two functions in the ADC module, sampling and analog-digital conversion. The Analog signal from the Coupling module 5 has to be sampled before being converted to the digital signal. In the sampling unit 20 of the preferred ADC module, bandpass sampling (BPS) theorem will be adopted in preference to Nyquist sampling theorem that is for baseband signals. The advantage of BPS theorem is that it is very efficient by lowering the sampling rate for a band pass signal so that the load of the A-D converter can be lowered considerably. The equation of bandpass sampling can be shown as the following equation:

$${f}_{s} = \frac{2 ( {f}_{L} + {f}_{H} )}{2 n + 1}$$

Where
fₛ is the sampling frequency.
F_{L} is the lower bound frequency of the passband.
F_{H} is the upper bound frequency of the passband.
N is the largest nonnegative integer that makes fₛ 2(f_{H}−f_{L}).

The DSP/FPGA module 3 is a key module not only in the receiver, but also in the whole modem.

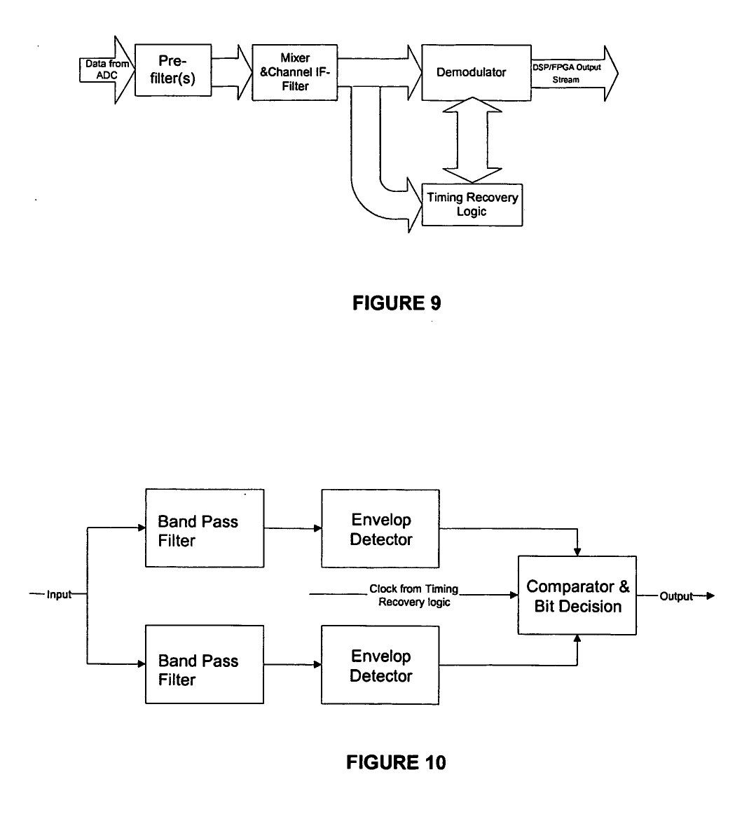

Data from the ADC module 7 can be input into the DSP/FPGA 14. Then the processed data is output to the micro-controller module 2. The DSP/FPGA chip is controlled by the Micro-controller module 2 and its program is stored in the memory unit. The function of each unit in DSP/FPGA module 14 is shown in FIG. 9.

The Pre-filter 22 ideally is a FIR bandpass filter for single carrier modulation communication or a group of FIR bandpass filters for multi-carrier modulation communication. The purpose of the pre-filter(s) is to reduce the noise from the power-line (communication channel).

The Mixer and IF-Filter (intermediate frequency filter) 23 will move the signal to a proper frequency or a frequency which is easy for the DSP to process which is usually a low frequency, and further reduce the noise so that it is easier for the demodulator 24 to process.

The carrier frequency and the dock of the received signal will be recovered in the timing recovery logic 25.

The baseband signal will be recovered in the demodulator 24. As for modulation, there are a number of algorithms which may be used for demodulation.

For the single carry FSK signal there are several algorithms which may be used for demodulation, the block diagram of one is shown in FIG. 6.

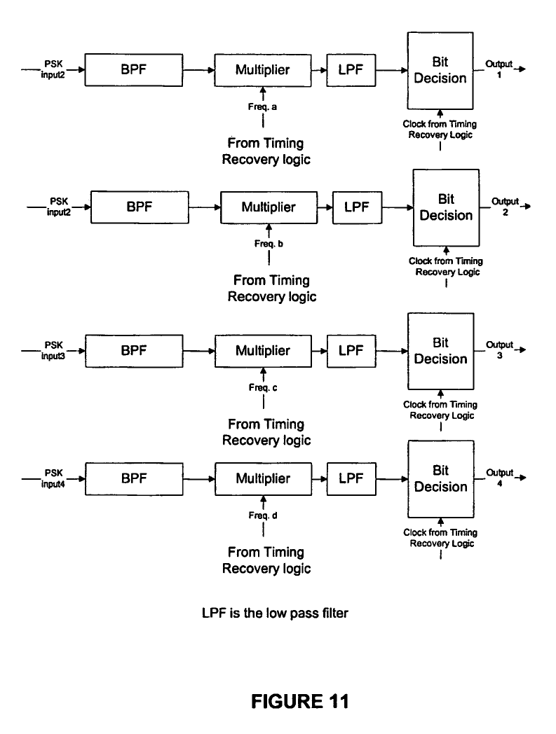

For the 4-carrier PSK, one of the demodulation diagrams is shown in FIG. 11.

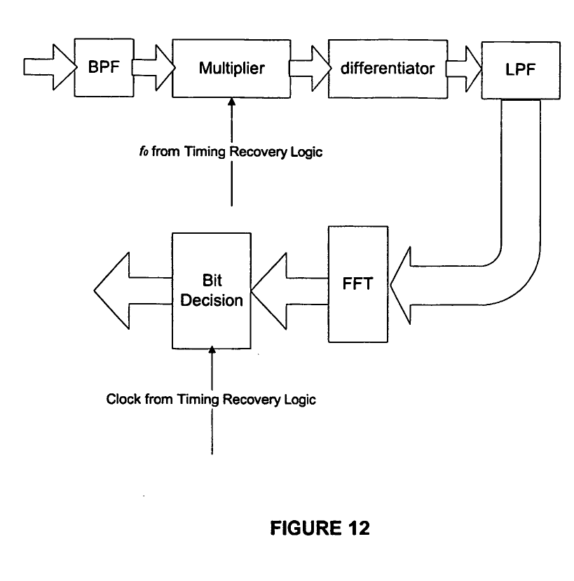

For the OFDM-FM, the block diagram of a demodulator is shown in FIG. 12.

The micro-controller module can be the same as that used in the transmitter.

The local interface module again provides an interface between the Micro-controller module and the other devices.

The present invention solves a significant problem in the market place. Currently as there is no international standard for power-line communication, existing products from different companies are not compatible as they use different standards developed by each company. For example, Intellon and Inari power-line network products are not compatible. If a person wishes to access an Intellon power-line network, they will require an Intellon modem. Similarly if a person wishes to access an Inari power-line network, they will require a Inari modem. Thus if the person wishes to access both Intellon and Inari networks they will require two separate modems. With the present invention, the person will not require separate modems but rather can set the modem to the proper mode, for example, Intellon's OFDM-FM mode or Inari's 4-carrier-PSK mode, ect. That is the present invention finally provides one modem for various types of power-line networks.

Whilst the method and apparatus of the present invention has been summarised and explained by illustrative application it will be appreciated by those skilled in the art that many widely varying embodiments and applications are within the teaching and scope of the present invention, and that the examples presented herein are by way of illustration only and should not be construed as limiting the scope of this invention.

1. A flexible modem for transmitting and receiving signals via power-lines, including:
a programmable transmitter using digital signal processing including a digital signal processor and a controller for the modem functional control, which includes wave shaping, coupling units needed to transmission process and computer bus interfaces;
a programmable receiver using digital signal processing including a digital signal processor and a controller for the modem functional control, which includes wave shaping, and coupling units needed in receiver process and computer bus interfaces;
at least one random access memory for storage of data;
a clock generator coupled to the transmitter and receiver.

2. The modem of claim 1, wherein said a transmitter includes a digital frequency synthesiser.

3. The modem of claim 1, wherein said receiver includes a digital timing recover unit.

4. The modem of claim 1, wherein said at least one random access memory includes a control program memory and an algorithm program memory.

5. The modem of claim 4, wherein said algorithm program memory has a plurality of algorithms in it.

6. A modem for transmitting and/or receiving a signal via a power line, said modem including:
a local interface for providing a link between a device and said modem; a controller;
a modulation means;
a data conversion means;
a coupling means for providing a link between said modem and said power line; and
a memory means, said memory means storing a plurality of algorithms, each said algorithm being selectable by said controller, said controller selecting said algorithm and using said selected algorithm to convert said signal;
wherein to transmit said signal, said controller receives said signal from said local interface and converts said signal using said selected algorithm into a format acceptable by said power line, said converted signal is modulated by said modulation means and passed to said data conversion means to convert said signal into an analog signal, said coupling means then transfers said analog signal into said power line; and
wherein to receive said signal, said data conversion means receives said signal from said coupling means and converts said signal using said selected algorithm into a digital signal, said digital signal is demodulated in said modulation means and forwarded to said controller, said controller converts said signal into a format acceptable by said device, and said local interface outputs said data to said device.

7. A modem as claimed in claim 6 wherein said data conversion means includes a sampling means to sample said signals before being converted into digital signals.

8. A modem as claimed in claim 6 wherein said data conversion means includes an amplifier means to amplify said analog signals.

9. A modem as in claim 6 wherein said modulation means includes a memory means for storing at least one algorithm for the modulation or demodulation of said signals.

10. A modem as in claim 6 wherein said coupling means includes a balun and two capacitors arranged to insulate said signal from said power line. means include at least one FIR bandpass-filter.

11. A modem as in claim 6 wherein said modulation means include at least one FIR bandpass-filter.

12. A transmitter for transmitting data across a power line, said transmitter including:
a local interface for a receiving said data from a device;
a memory means for storing a plurality of algorithms;
a controller for selecting an algorithm from said memory means, receiving said data from said local interface and converting said data using said selected algorithm into a power line network data format;
a modulation means for modulating said data in said power line network data format to create a digital power line signal;
a digital to analog converter for converting said digital power line signal into an analog power line signal; and
a coupling means to enable said analog power line signal to be transferred into said power line.

13. A transmitter as claimed in claim 12, further including an amplifier means to amplify said analog signals.

14. A transmitter as claimed in claim 12 wherein said controller includes a memory means for storing at least one algorithm for the conversion of signals.

15. A transmitter as in claim 12 wherein said modulation means includes a memory means for storing at least one algorithm for the modulation of said signals.

16. A transmitter as claimed in claim 12 wherein said modulation means includes at least one of FIR bandpass-filter.

17. A receiver for receiving an analog power line signal from a power-line, said receiver including: a coupling means to enable said analog power line signal to be received; an analog to digital converter for converting said analog power line ignal into a digital power line signal;
a demodulator means for demodulating said digital power line signal into a memory means for storing a plurality of algorithms;
a controller for selecting an algorithm from said memory means, and converting said data using said selected algorithm into a required interface protocol format; and
a local interface for outputting said data in said interface protocol format to a device.

18. A receiver as claimed in claim 17 further including a sampling means to sample said signals before being converted into digital signals.

19. A receiver as in claim 17 wherein said demodulator means includes a memory means for storing at least one algorithm for the demodulation of said signals.

20. A receiver as in claim 17 wherein said demodulator means includes a memory means for storing at least one algorithm for the demodulation of said signals.

21. A method for transmitting data across a power line, including the steps of: selecting an algorithm for use in the conversion of said data;
converting said data using said selected algorithm into a power line network data format;
modulating said data in said power line network data format to create a digital power line signal;
converting said digital power line signal into an analog power line signal;
transferring said analog power line signal into said power line.

22. A method of processing analog power line signals from a power line, including the steps of: receiving said analog power line signal;
converting said analog power line signal into a digital power line signal;
demodulating said digital power line signal into data;
selecting an algorithm for use in the conversion of said data;
converting said data using said selected algorithm into a required interface protocol format; and
outputting said data in said interface protocol format to a device.
